(19) United States
(12) Patent Application Publication
(10) Pub. No.: US 2002/0147684 A1
(43) Pub. Date: Oct. 10, 2002

(54) Self-service terminal

(75) Inventors: James S. Kirkhope, Perth (GB); Mark M. Grossi, Dundee (GB)

Correspondence Address: MICHAEL CHAN, NCR CORPORATION, 1700 SOUTH PATTERSON BLVD, DAYTON, OH, 45479-0001, US

(73) Assignee: NCR Corporation

(21) Appl. No.: 10/119,120

(22) Filed: Apr. 9, 2002

(30) Foreign Application Priority Data
Apr. 10, 2001 (GB) 0108897.0

(51) Int. Cl. G06F 17/60

(52) U.S. Cl. 705/43; 705/42

(57) ABSTRACT

A self-service terminal (12) for presenting personalized information to a user is described. The terminal comprises presentation means (32) for presenting a user with transaction information, user input means (34,36) for allowing a user to input transaction details, and user identification means (44) for identifying a user. The terminal (12) further comprises a non-transaction display (42), and processing means (50) for controlling the non-transaction display, where the processing means (50) is in communication with the user identification means (44) and with a personalization database (26), whereby, during a transaction, the terminal presents personalized information to a user via the non-transaction display (42) independently of the transaction.

### BACKGROUND OF THE INVENTION

The present invention relates to a self-service terminal (SST), such as an automated teller machine (ATM) or a non-cash kiosk. In particular, the invention relates to an ATM for displaying personalized information such as targeted advertisements.

ATMs are public access terminals that provide a convenient, reliable, and secure source of cash and other financial transactions and services in an unattended environment. As a result, a financial institution's interaction with many of its customers (account holders) may be predominantly, and in some cases exclusively, via an ATM.

To reach these customers with advertisements and marketing information relating to financial products and services, financial institutions include advertisements on ATM screens. The term “screen” is used herein to denote the graphics, text, controls (such as menu options), and such like, that are displayed on an SST monitor; the term “screen” as used herein does not refer to the hardware (that is, the monitor) that displays the graphics, text, controls, and such like.

There are two general approaches to advertising on ATM screens. One approach is to present an advertising screen before a transaction commences (referred to as an “attract sequence”), and during a period in a transaction in which an ATM obtains authorization from a remote host (referred to as a “dead time”). The second approach is to provide a second display (typically located near the first display) that is dedicated to displaying advertising information.

One disadvantage with the first approach is that once a user approaches the ATM and initiates a transaction (for example, by inserting his/her card), then the advertising must stop to allow the user to enter a transaction; thus, the advertising stops as soon as the user arrives. Another disadvantage associated with the first approach is that there is limited time during the “dead time” for displaying advertisements, typically a few seconds. A further disadvantage is that, typically, information relating to the identity of the user is stored in the remote host, so that advertisements shown during the “dead time” are not personalized to the user, but are generic. Generic advertisements are generally less likely to generate user interest than advertisements that are targeted at a user's interests or preferences.

The words “personalized information”, when used herein, refer to information that is targeted at an identified individual and that includes some reference to the individual's identity.

One disadvantage associated with the second approach is that the second display presents generic advertisements independently of a transaction being executed and independently of the identity of a user who is executing a transaction. As a result, users may not pay much attention to the second display.

### SUMMARY OF THE INVENTION

It is among the objects of an embodiment of the present invention to obviate or mitigate one or more of the above disadvantages or other disadvantages associated with prior art self-service terminals.

According to a first aspect of the present invention there is provided a self-service terminal for presenting personalized information, the terminal comprising presentation means for presenting a user with transaction information, user input means for allowing a user to input transaction details, and user identification means for identifying a user, characterized in that the terminal further comprises a non-transaction display and processing means for controlling the non-transaction display, where the processing means is in communication with the user identification means and with a personalization database, whereby, during a transaction, the terminal presents personalized information to a user via the non-transaction display independently of the transaction.

The presentation means may be a first display, such as a cathode ray tube (CRT), a liquid crystal display (LCD), a plasma panel, or such like. Alternatively or additionally, the presentation means may be audio-based, such as a loudspeaker arrangement.

The user input means may comprise one or more of: an encrypting keypad, a keyboard, function display keys (FDKs), a touchscreen panel, a mouse, a joystick, a microphone, or such like.

The user identification means may comprise a card reader/writer, such as a magnetic card reader/writer, a smart card reader/writer, a hybrid smart/magnetic card reader/writer, or such like. Alternatively, the user identification means may comprise a biometric sensor arrangement; for example, a human iris recognition system, a fingerprint recognition system, a voice recognition system, a facial recognition system, or such like.

The user identification means is able to read a physical identification token (for example, a magnetic stripe card, a smart card, a human iris, a fingerprint, or such like) and to generate a logical identification token from the physical identification token.

A logical identification token is a software representation of a physical identification token presented by a user; for example, if a user's physical token is a magnetic stripe card, then the logical token is data from that card, such as the account or card number, the card issuer, the card expiry date, and such like. If a user's physical token is related to part of his/her body (for example, an iris), then the logical token is data derived from a measurement of that part of the body (for example, an iris code). Thus, examples of logical identification tokens include: data from a magnetic stripe or smart card, an iris code derived from an image of a human iris, a fingerprint code derived from measurements of a fingerprint, and such like.

The non-transaction display may be any convenient display, such as a CRT, an LCD, a plasma panel, or such like.

The non-transaction display processing means may comprise a display controller for controlling the non-transaction display, a token processor for receiving an identification token from the user identification means, and a personalization database interface for accessing a personalization database.

The personalization database may be stored locally, that is, within the terminal; or remotely, for example, in a remote host or in a remote server; or part of the database may be stored locally, and another part of the database may be stored remotely.

The display controller may include a conventional video card (including a video chipset, bios, and memory) and non-volatile memory for storing information that is frequently presented on the display. This frequently presented information may be information that is common to many users, but which is personalized by adding information that is specific to an identified user.

The token processor may be coupled to the user identification means by a physical cable, such as an RS232 connection, or by wireless communication, such as a Bluetooth (trade mark) connection.

The token processor may also receive command data from a terminal controller so that the token processor is notified when a user has completed a transaction at the terminal.

The personalization database interface preferably includes a wireless transceiver, such as a cellular radio-frequency transceiver, so that the database interface can obtain personalization data independently of any network connection in the terminal.

This has the advantage that an installed self-service terminal can be retro-fitted with an additional display and associated display processing means, without having to update the network infrastructure, for example, by adding cables.

By virtue of this aspect of the invention, a terminal is able to access a database of targeted advertisements independently of the controller that authorizes transactions from the terminal, and the terminal is able to present advertisements targeted at the current user of the terminal on a dedicated display asynchronously with a transaction being executed. The terminal is also able to halt targeted advertisements when a user completes a transaction.

According to a second aspect of the present invention there is provided a method of presenting personalized information to a user at a self-service terminal, the method comprising the steps of: receiving identification information from a user; accessing a personalization database using the identification information to obtain personalized information; and presenting the personalized information to the user on a non-transaction display throughout a transaction and independently of the transaction.

The step of accessing a personalization database using the identification information to obtain personalized information may include the step of: retrieving personalized information from the database. Alternatively, the step of accessing a personalization database using the identification information to obtain personalized information may include the step of: retrieving from the database a pointer to personalized information; and accessing personalized information using this pointer.

According to a third aspect of the present invention there is provided a method of presenting personalized information to a user at a self-service terminal, the method comprising the steps of: receiving identification information from a user; accessing through a first channel a personalization database using the identification information; retrieving through the first channel personalized information from the database; presenting the personalized information to the user via first presentation means; receiving a transaction request from a user; providing transaction details to the user via second presentation means; and authorizing the transaction through a second channel; whereby the personalized information is retrieved and presented independently of the transaction details.

The database may be stored locally and the first channel may be an internal bus. Alternatively, the database may be stored remotely, and the first channel may be a wire or wireless connection.

The database may store personalized information that is presented to the user, or a pointer to personalized information that is presented to the user.

The first presentation means may be audio-based, such as a loudspeaker arrangement, but more preferably, is visual, such as a CRT. Similarly, the second presentation means may be audio-based or visual.

According to a fourth aspect of the present invention there is provided a method of presenting personalized information to a user at a self-service terminal, the method comprising the steps of: displaying personalized information obtained using a database accessed via an insecure channel; and displaying on a different display transaction details accessed via a secure channel.

According to a fifth aspect of the present invention there is provided a system for displaying personalized information to a user at a self-service terminal, the system comprising: a self-service terminal according to the first aspect of the invention; and a personalization database storing personalized information for a plurality of users.

According to a sixth aspect of the present invention there is provided a self-service terminal for presenting targeted information, the terminal comprising presentation means for presenting a user with transaction information, user input means for allowing a user to input transaction details, and user identification means for identifying a user, characterized in that the terminal further comprises a non-transaction display and processing means for controlling the non-transaction display, where the processing means is in communication with the user identification means and with a database, whereby, during a transaction, the terminal presents targeted information to a user via the non-transaction display independently of the transaction.

### BRIEF DESCRIPTION OF THE DRAWINGS

These and other aspects of the present invention will be apparent from the following specific description, given by way of example, with reference to the accompanying drawings, in which:

FIG. 1 is block diagram of a self-service terminal network according to one embodiment of the present invention;

FIG. 2 is a pictorial diagram showing a part (an SST) of the network of FIG. 1 in more detail;

FIG. 3 is a block diagram showing a part (a display processing unit) of the SST of FIG. 2 in more detail;

FIG. 4 illustrates one example of an entry in a database stored in the host of FIG. 1;

FIG. 5 illustrates an example of an advertisement table created in the SST of FIG. 2 and referenced by the entry of FIG. 4; and

FIG. 6 illustrates two screens presented simultaneously on the SST of FIG. 2.

### DETAILED DESCRIPTION

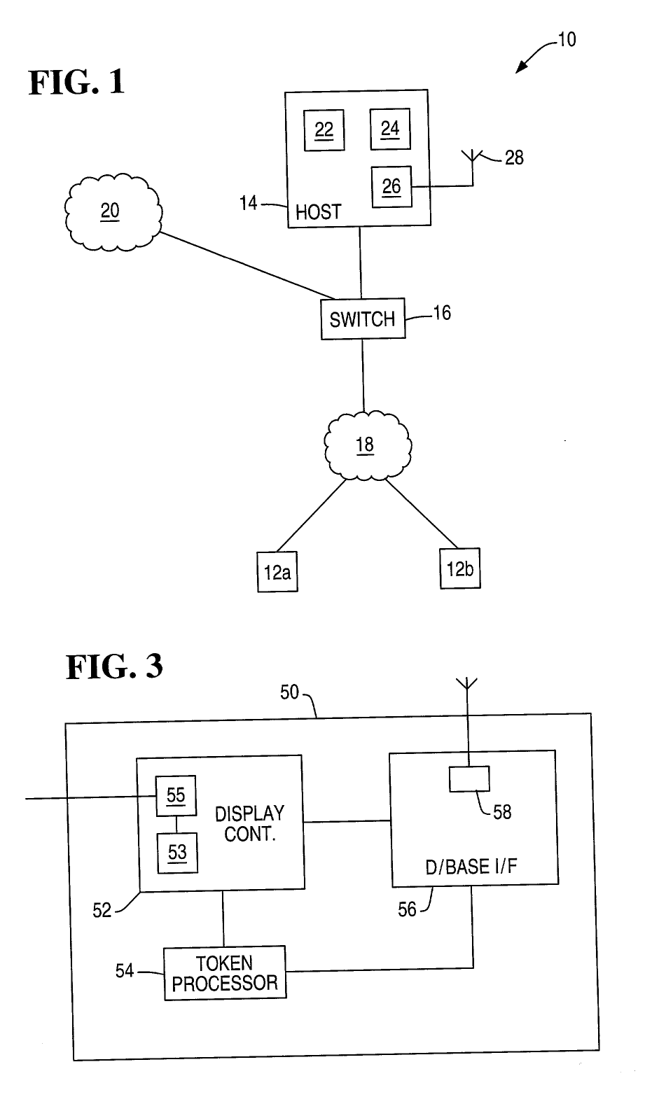

Reference is now made to FIG. 1, which is a simplified block diagram of an SST network 10, in the form of an ATM network, according to one embodiment of the present invention. The ATM network 10 is owned and operated by a financial institution, and comprises a plurality of ATMs 12 (only two of which are shown) connected to a host 14 via a transaction switch 16 and a secure network 18. The switch 16 is also connected to interchange networks 20 for authorizing transactions relating to accounts held with other institutions (referred to herein as third party institutions).

The host 14 includes a card services facility 22 for validating a claimed identity of a user at one of the ATMs 12, an account services facility 24 for authorizing transactions from an account held by an identified user, and a personalization database 26 for storing personalized information relating to the financial institution's account holders.

The personalization database 26 includes a cellular radio-frequency transceiver (illustrated by antenna 28) for wireless communication.

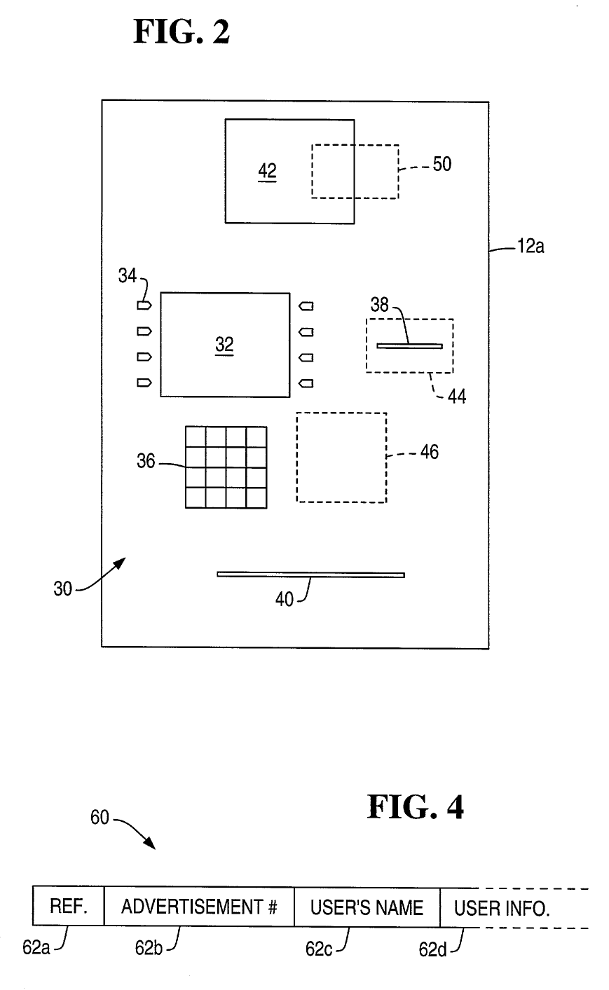

Reference is now made to FIG. 2, which is a simplified pictorial view of an upper portion of the ATM 12a. ATM 12a includes a user interface 30 comprising: a first (transaction) display 32, function display keys (FDKs) 34 aligned as two columns, one column on either side of the display 32; an encrypting keypad 36, a card entry/exit slot 38, a cash dispense slot 40, and a second (non-transaction) display 42.

The card entry/exit slot 38 aligns with a motorized card reader/writer module (MCRW) 44 (shown in broken line) located within the ATM 12a. A controller module 46 (shown in broken line) controls the operation of the ATM 12a and is connected to the modules within the ATM 12a. The non-transaction display 42 is driven by processing means 50 in the form of a display processing unit (shown in broken line).

The ATM 12a also includes conventional modules, such as a cash dispenser, a network connection, a journal printer, and such like. None of these modules is shown in FIG. 2; as these modules are well known to those of skill in the art they are not described herein.

Reference is now made to FIG. 3, which shows the display processing unit 50 in more detail. The unit 50 comprises: a display controller 52; a token and command processor 54 coupled to the controller module 46; and a personalization database interface 56. The controller 52, processor 54, and interface 56 are mutually interconnected.

The display controller 52 includes a non-volatile memory 53 for storing advertisements relating to products and services that the financial institution wishes to market. The display controller 52 also includes a video card 55 for controlling the non-transaction display 42.

The token and command processor 54 is able to receive and process a logical identification token from the MCRW 44 (via the controller module 46) and status commands relating to modules within the ATM 12a.

The personalization database interface 56 is able to access the personalization database 26 and update the display controller 52 with retrieved personalized information. The personalization database interface 56 includes a cellular radio-frequency transceiver 58 for wireless communication with the personalization database 26 via the database's transceiver 28.

Referring again to FIG. 1, and also to FIG. 4, the personalization database 26 includes an entry for each of the financial institution's account holders who has an ATM card (that is, a card that can be used to withdraw funds using an ATM). A simplified entry is shown in FIG. 4. The entry 60 comprises a plurality of fields 62 including: a reference field 62a, an advertisement number field 62b, a user name field 62c, and additional user information fields 62d.

Reference field 62a includes a unique reference that associates part of a logical token presented by a user (such as the user's account number or card number) with the user's identity. The reference field 62a enables the database 26 to receive a claimed identity from an ATM 12 (which may be a user's account number from a magnetic stripe card inserted by the user) and to select the unique entry 60 in the database 26 associated with that claimed identity.

Advertisement number field 62b stores a pointer to the advertisement or advertisements to be presented to the user. This field 62b facilitates mapping of advertisements to users by referencing an entry in an advertisement table (which will be described in more detail below).

User name field 62c stores the name by which the user likes to be addressed. This user name could be formal, for example, “Mr Smith”; or informal, for example, “John”.

User information field 62d (which may comprise a plurality of sub-fields) enables additional details about the user to be stored, such as the user's age, gender, and amount of funds held in the user's accounts, if the user is willing to allow the institution to store this information on the database 26.

If the financial institution desires to market a new product or service, the institution will identify suitable targets (ATM users) for the new product or service. Once suitable targets have been identified, the institution will update the targeted users' database entries 60 by including a reference to an advertisement for the new product or service in the advertisement number field 62b.

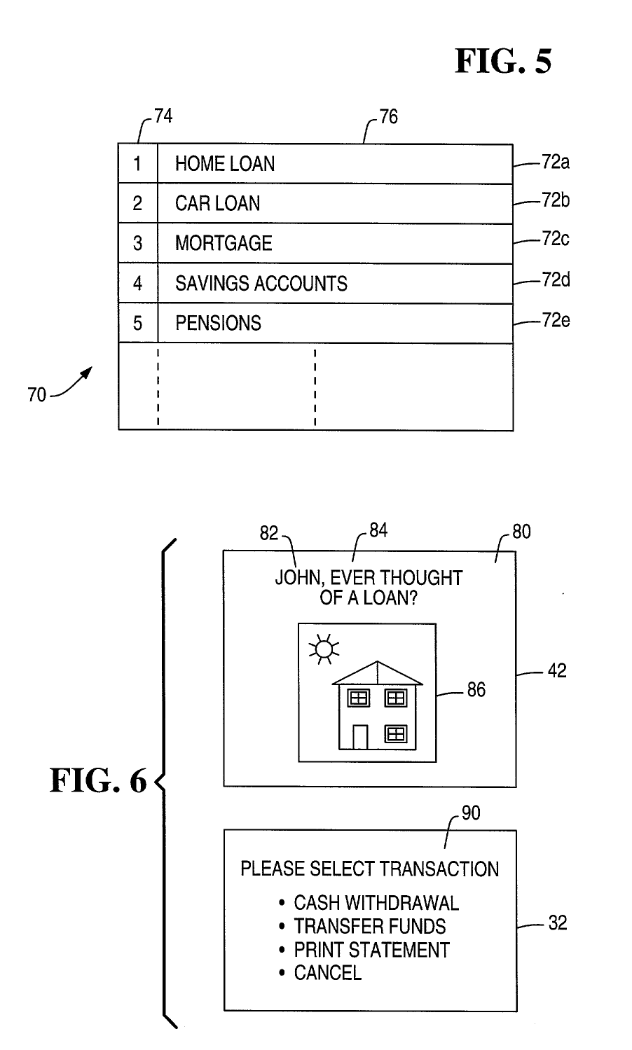

Advertisements for products and services are stored in an advertisement table in the non-volatile memory 53 of the display controller 52, as shown in FIG. 5. These advertisements may be loaded into the non-volatile memory 53 either locally by a person at the ATM 12a; or remotely, preferably at a period of low ATM activity, such as during a night.

Advertisement table 70 comprises a plurality of entries 72, each entry 72 having an identification field 74 (containing an advertisement number) and an advertisement field 76 (containing an advertisement to be displayed). In table 70 there are five different advertisements, each advertisement is a full-motion MPEG video.

An example of a typical transaction at the ATM 12a will now be described with reference to FIGS. 1 to 5.

A user inserts his card into the card entry/exit slot 38. The MCRW 44 draws in the card, reads the card, and conveys the read card data (logical identification token) to the controller 46. The controller 46 conveys the data to the token and command processor 54.

The ATM 12a then simultaneously:

1. identifies and displays a targeted advertisement, and

2. processes a transaction.

This is achieved by the display processing unit 50 communicating with the database 26 simultaneously with and independently of the ATM controller 46 communicating with the host 14.

The operation of the display processing unit 50 in identifying and displaying a targeted advertisement will be described first, as the transaction processing function is identical to that of a conventional ATM.

On receiving the logical identification token, the token processor 54 determines whether the database stores information relating to this user. This is performed by the token processor 54 examining card issuer information from the logical token to determine if the financial institution issued the card or if the card was issued by a third party institution.

If the card was issued by a third party institution then the token processor 54 instructs the display controller 52 to display a generic (non-targeted) advertisement to the user because the database 26 does not store any personalized information relating to the user.

If, however, the card was issued by the financial institution then the token processor 54 extracts the user's account number from the token and sends this account number to the database interface 56, which conveys this user account number to the database 26.

Database 26 uses this account number to access the entry 60 relating to the user. From this entry 60, the database 26 reads the advertisement number in the advertisement table 70 that is pointed at by the advertisement number field 62b, and the user's name from the user name field 62c. In this example, advertisement number one (a home loan) is pointed at by field 62b, and the user's name is “John”.

The database 26 then conveys this number and name (via transceivers 28 and 58) to the database interface 56, which conveys the number and name to the display controller 52. The display controller 52 uses this received number to access the appropriate entry 72 in the advertisement table 70, in this example, entry number one 72a. The video card 55 then presents a screen on the non-transaction display 42. The screen includes the user's name (“John”) and incorporates the selected advertisement (for a home loan), and some text relating to the advertisement.

From the user's perspective, the user enters his card into the card entry/exit slot 38, enters his PIN using keypad 36, selects a transaction option (in this example, cash withdrawal) using an FDK 34, and selects the amount to be withdrawn using either the keypad 36 or an FDK 34. At some point during this sequence, the non-transaction display 42 will display the personalized information (in the form of the home loan video).

As the display processing unit 50 only has to retrieve a reference number from the database 26, there should be very little delay between a user entering his card and the non-transaction display playing the home loan video sequence.

When the user has entered all required transaction details, the ATM controller 46 obtains authorization for the transaction via secure network 18, switch 16, and host 14. At this time, the ATM controller 46 sends a status code to the token and command processor 54 to indicate that a transaction is being authorized.

When the transaction has been authorized, the ATM controller 46 instructs the MCRW 44 to present the user's card to the user. When the user removes his card from card slot 38 then the ATM controller 46:

1. instructs the cash dispenser (not shown) to dispense the requested amount of cash, and

2. informs the token and command processor 54 that the user has removed his card.

The token and command processor 54 instructs the display controller 52 to terminate presentation of the home loan video if it is still being displayed.

The display controller 52 may then present a generic advertising video as part of an attract sequence.

FIG. 6 illustrates the two displays at a certain point during the above transaction, where two different screens are shown simultaneously on the respective displays. The non-transaction display 42 presents a screen 80 incorporating the user's name 82, text 84 associated with the advertisement for a home loan, and executing a video 86 for a home loan. The transaction display 32 presents a screen 90 inviting the user to select a transaction type.

It will now be apparent that this embodiment of the present invention has the advantage that targeted information can be presented to a user throughout a transaction without delaying or otherwise interfering with the transaction, and the targeted information is also personalized to the user. By using a different channel to communicate the personalized information, the limitations associated with most ATM networks (bandwidth, security, and such like) are avoided.

Various modifications may be made to the above described embodiment within the scope of the invention, for example, in other embodiments, the database may store in each entry information personalized to the user referenced by that entry. In other embodiments, personalized information may be in a format other than video, for example, audio or text.

In other embodiments, the personalized information may relate to marketing material. In other embodiments, the personalized information may comprise advertisements relating to other companies or institutions, and the institution owning and/or operating the ATM may charge a fee for the marketing material or advertisements presented.

In other embodiments, the advertisement table may be stored in the database 26. The advertisements may be stored in a streaming format so that they can be streamed to an ATM.

In other embodiments, the terminal may be a non-cash kiosk.

In other embodiments, the information may be targeted at an identified user but may be anonymized, that is, the information may not include any reference to the user's name or any other reference that may identify the user.

What is claimed is:

1. A self-service terminal for presenting personalized information, the terminal comprising:
presentation means for presenting a user with transaction information;
user input means for allowing a user to input transaction details;
user identification means for identifying a user;
a non-transaction display; and
processing means for communicating with the user identification means and with a personalization database to present personalized information to a user via the non-transaction display during a transaction and independently of the transaction.

2. A terminal according to claim 1, wherein the processing means includes a display controller for controlling the non-transaction display, a token processor for receiving an identification token from the user identification means, and a personalization database interface for accessing a personalization database.

3. A terminal according to claim 2, wherein the display controller includes a video controller and non-volatile memory for storing information that is frequently presented on the display.

4. A terminal according to claim 2, wherein the token processor includes means for receiving command data from a terminal controller so that the token processor is notified when a user has completed a transaction at the terminal.

5. A terminal according to claim 2, wherein the personalization database interface includes a wireless transceiver so that the database interface can obtain personalization data independently of any network connection in the terminal.

6. A method of presenting personalized information to a user at a self-service terminal, the method comprising the steps of:
receiving identification information from a user;
accessing a personalization database based upon the identification information to obtain personalized information; and
presenting the personalized information to the user on a non-transaction display throughout a transaction and independently of the transaction.

7. A method according to claim 6, wherein the step of accessing a personalization database using the identification information to obtain personalized information includes the step of:
retrieving personalized information from the database.

8. A method according to claim 6, wherein the step of accessing a personalization database using the identification information to obtain personalized information includes the step of:
retrieving from the database a pointer to personalized information; and
accessing personalized information using this pointer.

9. A method of presenting personalized information to a user at a self-service terminal, the method comprising the steps of:
receiving identification information from a user;
accessing through a first channel a personalization database using the identification information;
retrieving through the first channel personalized information from the database;
presenting the personalized information to the user via a first presentation unit;
receiving a transaction request from a user;
authorizing the transaction through a second channel; and
providing transaction details to the user via a second presentation unit, wherein the personalized information is retrieved and presented independently of the transaction details.

10. A method of presenting personalized information to a user at a self-service terminal, the method comprising the steps of:
displaying personalized information obtained using a database accessed via an insecure channel; and
displaying on a different display transaction details accessed via a secure channel.

11. A system for displaying personalized information to a user at a self-service terminal, the system comprising:
a personalization database for storing personalized information for a plurality of users; and
a self-service terminal including (i) a first user display and a second user display, (ii) first processing means for retrieving at least some personalized information from the personalization database and displaying the retrieved information on the first user display, and (iii) second processing means for processing a transaction and displaying transaction details on the second user display while the first processing means is retrieving at least some personalized information from the personalization database and displaying the retrieved information on the first user display.

12. A self-service terminal comprising:
a first user display for displaying transactional information associated with a user carrying out a transaction;
a second user display for displaying personalized information which is associated with a user and which is retrieved from a personalized database;
means for processing a transaction being carried out by a user and displaying transactional information associated with the transaction on the first user display during the transaction; and
means for retrieving at least some personalized information from a personalization database and displaying the retrieved information on the second user display while a transaction is being carried out by a user and transactional information associated with the transaction is being displayed on the first user display.

13. A method of operating a self-service terminal, the method comprising the steps of:
processing a transaction based upon inputs received from a user carrying out the transaction at the self-service terminal;
retrieving from a personalization database at least some personalized information associated with the user carrying out the transaction at the self-service terminal;
displaying on a first user display transactional information associated with the transaction being carried out at the self-service terminal; and
displaying on a second user display the at least some personalized information which is associated with the user carrying out the transaction at the self-service terminal while the transactional information associated with the transaction is being displayed on the first user display.
